(19) United States
(12) Patent Application Publication
(10) Pub. No.: US 2012/0254448 A1
(43) Pub. Date: Oct. 4, 2012

(54) SYSTEM AND METHOD FOR SELECTION OF NETWORK TRANSPORT WITHIN A MOBILE DEVICE

(75) Inventors: Thomas T. Wheeler, Frisco, TX (US); Robert W. Peterson, Plano, TX (US); Qin Ye, Plano, TX (US)

(73) Assignee: Recursion Software, Inc., Frisco, TX (US)

(21) Appl. No.: 13/078,942

(22) Filed: Apr. 2, 2011

(51) Int. Cl. G06F 15/16

(52) U.S. Cl. 709/227

(57) ABSTRACT

In a mobile device, one of a plurality of network transports may be used for a connection request. The ideal network transport may be selected by executing a connection selection policy that is stored within the device. The connection selection policy may include one or more network transport evaluators that are each configured to weight the available network transports according to various criteria. Examples of network transport evaluators include evaluators that are dependent on geolocation, security levels, or battery status.

### FIELD OF THE INVENTION

This disclosure relates to network transport mechanisms for mobile devices.

### BACKGROUND OF THE INVENTION

Mobile devices such as smartphones, PDAs and netbooks often have multiple network transports through which they can communicate, e.g. 3G, 4G, WiFi. When an application executing on a mobile device needs a network connection it must choose which of the several network transports to use at a given moment.

The standard solution for applications needing a network connection is to program the application to use a single transport based on either a user-provided selection or other pre-determined configuration means; or, for the application to attempt to establish a connection on multiple transports and use the first connection attempt that succeeds.

Using a single network transport is inflexible. Relying on users to choose the best network transport can result in a failure to establish connection, poor application performance or high costs due to user error. A simple fail-over policy does not take into consideration varying real-world conditions and application needs.

What is required, is an improved system and method for selecting a network transport.

### SUMMARY OF THE INVENTION

In one aspect of the disclosure, there is provided a method for selecting a network transport for a device from a plurality of network transports. The method comprises generating a connection request and referencing a connection selection policy to select a network transport. The device is then connected on the selected network transport.

In one aspect of the disclosure, there is provided a mobile device configured to execute one or more applications comprising generating a connection request and executing a connection selection policy in response to the connection request. The connection selection policy may be configured to select one network transport for a connection of the device from a plurality of network transports.

In one aspect of the disclosure, there is provided a non-transitory computer-readable storage medium comprising instructions for receiving a connection request for a mobile device and executing a connection selection policy to select a network transport from a plurality of network transports.

### BRIEF DESCRIPTION OF THE DRAWINGS

Reference will now be made, by way of example only, to specific embodiments and to the accompanying drawings in which:

FIG. 1 depicts a method for selecting a network transport for a device;

FIG. 2 schematically depicts a mobile device;

FIG. 3 depicts a process for returning the most suitable network transport for a connection request; and

FIG. 4 depicts a transport evaluator process.

### DETAILED DESCRIPTION OF THE INVENTION

It has been realized by the present inventors, that the ideal transport for a mobile device can depend on variables such as application requirements, available connections, bandwidth charges, the device's geolocation, user settings, and device configuration, some of which may change on a realtime basis.

The present disclosure thus provides a policy-based mechanism by which an application on a mobile device can obtain a network connection using one of several transports. The application provides the policy with a set of connection characteristics, and the policy will utilize these characteristics along with the device's state (geolocation, battery life, available network transports, user-specified preferences, etc.) to provide the application with a network connection that best matches the specified characteristics.

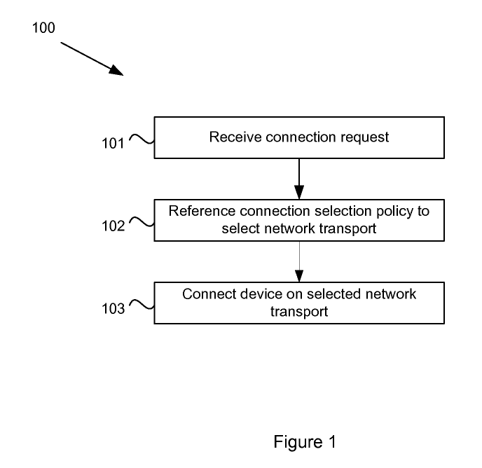

A method for selecting a network transport is depicted in the flowchart 100 of FIG. 1. At step 101, a connection request is generated for the device, e.g. by an application executing on the device. At step 102, the device references an internal connection selection policy to select a network transport and then the device is connected on the selected network transport (step 103).

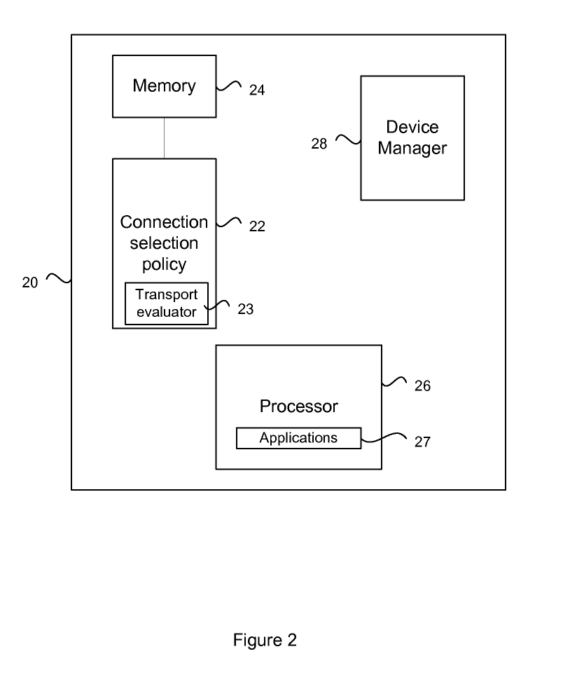

A schematic of a mobile device is depicted in FIG. 2. The mobile device 20 may be any suitable device or operating environment, such as a smartphone, that provides multiple network transports for communication. The mobile device 20 stores a connection selection policy 22 having one or more transport evaluators 23. The connection selection policy may be stored within a memory 24 of the mobile device. The mobile device also includes one or more processors 26 that are capable of executing applications 27 as well as executing the connection selection policy 22. The mobile device may also include a device manager 28 which is able to determine various parameters of the device, such as a device state, battery state, signal strengths, available network transports, etc.

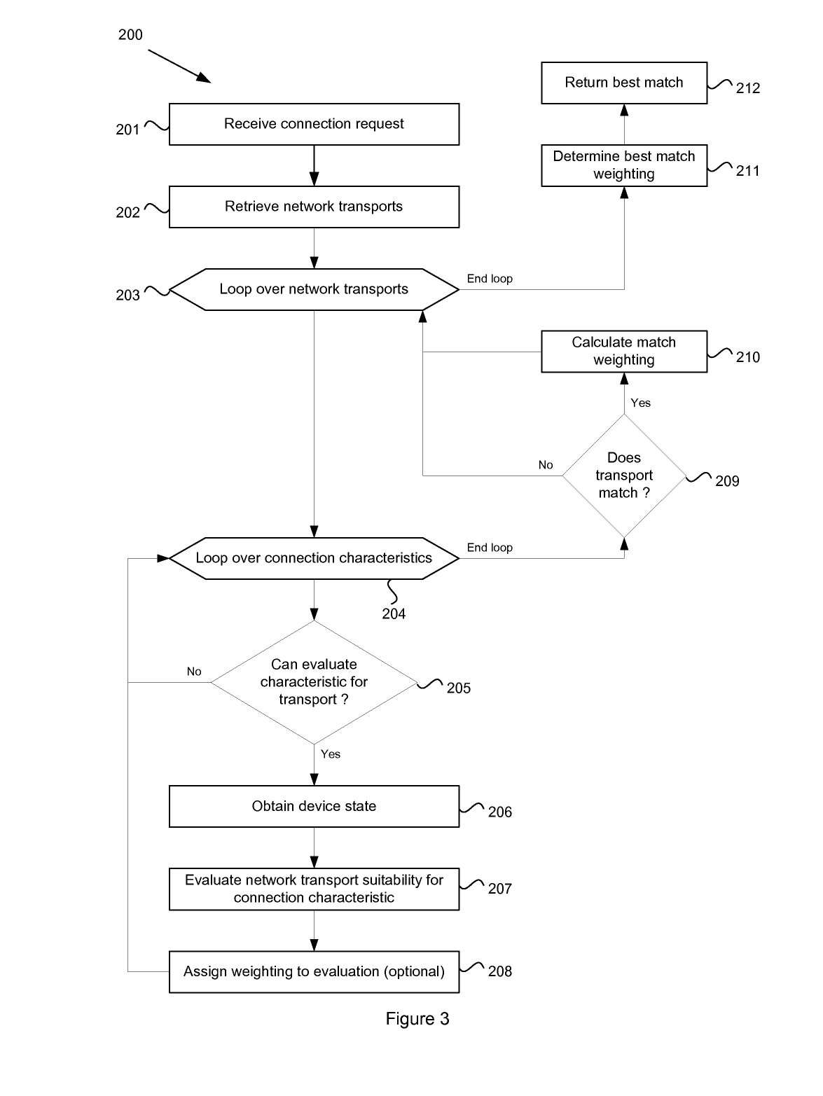

Referring now to FIG. 3, there is shown a more detailed process 200 of the network transport selection mechanism. Prior to the process 200, the connection selection policy is initialized with one or more transport evaluators. In various embodiments, the transport evaluators may be implemented in application code or may be provided by another source. Examples of evaluators include a Geolocation Evaluator, a Security Evaluator and a Battery Conserving Evaluator. A Geolocation Evaluator works by weighting one transport highly when the device is in a certain geographical area, and weighting another transport highly when the device is in another area. A Security Evaluator works by giving a higher weighting to the transport that provides the best encryption capabilities. A Battery Conserving Evaluator works by giving a higher weighting to the transport that uses the least power. When battery levels are low, it may give all transports a low weighting. Other types of evaluators that can be implemented in a connection selection policy may be apparent to a person skilled in the art and all such evaluators are intended to be encompassed herein.

The selection process 200 commences at step 201 when a connection request is generated and received into the connection selection policy. The connection request may be generated by an application executing on the mobile device. The application may be a voice or text based application, a support application or a data based application, an agent based application etc. The connection selection policy receives the connection request.

The connection policy then retrieves the available network transports via API calls to the mobile device's operating system (step 202) and loops over each network transport 203. For a first selected transport, each transport evaluator is called in a loop 204 and passed the transport for evaluation. The transport evaluator first determines whether it is capable of evaluating the transport (step 205). If so, the transport evaluator obtains the necessary device state from the device manager 28 (step 206) and analyzes the transport based on the transport evaluator's configuration and the device state to determine its suitability. The result of the analysis may be a simple boolean value, a numerical rating, or some other value that will indicate suitability. For example, a 3G network transport is evaluated against a High Bandwidth Evaluator. The current device state indicates that 3G connectivity is poor (one or two “bars”). The result of the analysis may be a boolean result “false” indicating it is not suitable, or an integer result between 1 and 10 such as “2” indicating the network transport is a poor match for the High Bandwidth Evaluator. The device state used in the analysis may include such information as geolocation, battery life, available network transports, user-specified preferences, etc. Other parameters will be apparent to a person skilled in the art. While the step of obtaining the device state is shown as a discrete step of the loop 204, the device state may also be obtained with the network transport list and passed to the respective transport evaluator.

A weighting may optionally be assigned to the analysis (step 208). Once the network transport has been evaluated, or if the network transport cannot be evaluated, the loop 204 iterates to the next transport evaluator.

The loop 204 is repeated for each transport evaluator. After the transport has been evaluated against each evaluator, the connection selection policy determines whether the transport is a match. If none of the evaluators rejected the transport a match is indicated, and a numerical match weighting for that transport may be optionally calculated (step 210) in accordance with specifications in the policy. The weighting is calculated based on the values returned from each evaluator, for example as a simple average.

The loop 203 is repeated for each network transport that is available. Thus, at the completion of loop 203, all network transports have been evaluated by all transport evaluators.

Once all the evaluators have finished their analysis, the numerical weightings for each transport are compared to determine the best match weighting (step 211). The transport that has the highest weighting is returned as the selected network transport for the connection request (step 212).

Once the network transport has been selected, the device may satisfy the connection request and the connection may proceed on the selected network transport. The specific methods for connecting devices on networks are well known to persons skilled the art and are not considered essential for the present disclosure. No further discussion of these specific connection methods is considered necessary here.

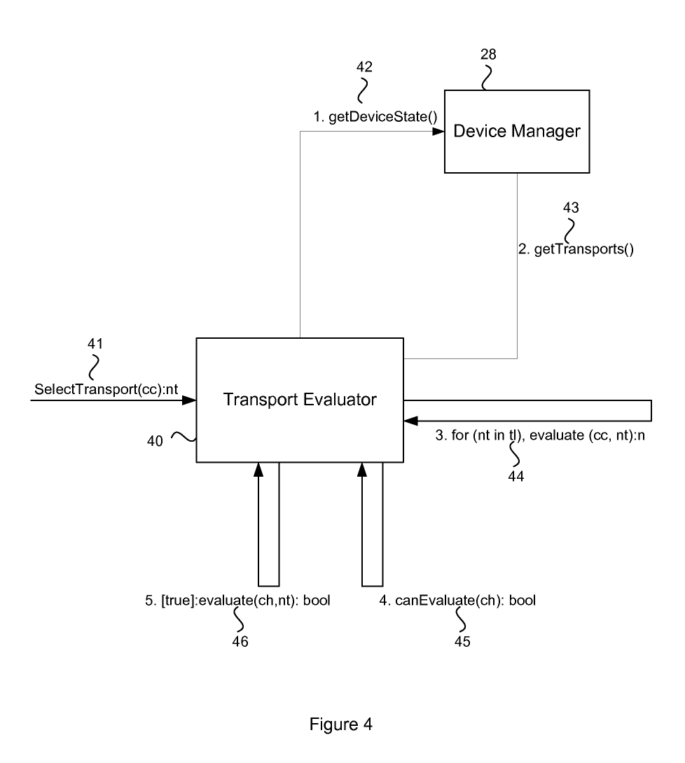

An embodiment of a process undertaken by a specific transport evaluator is illustrated in FIG. 4. The transport evaluator 40 receives a EvaluateTransport request 41 which is passed with a network transport. The transport evaluator 40 passes a getDeviceState( ) request 42 to the device manager 28 which returns a parameter list of device parameters, such as geolocation, battery life, available network transports, user-specified preferences, etc. Other parameters will be apparent to a person skilled in the art. The transport evaluator then determines whether the network transport can be evaluated for the current device state and its current configuration. If so, it then determines whether the network transport is suitable for use and returns an appropriate result, such as a boolean true/false or numerical rating. If the network transport could not be evaluated, the evaluator returns an appropriate error condition.

The connection selection policy may be configured to require that a minimum weighting be required to return a transport. In this case, if no transport meets this requirement after the evaluators have performed their analysis, the policy will return an error result indicating that no transport with the minimum weighting was found. This may be vital in the case of minimum security requirements.

The connection selection policy may be implemented as part of a software library for general purpose use by distributed applications running in mobile devices. The invention may be a stand-alone library or provided as part of a larger product such as a web browser client library, Web Services library, or RPC/ORB library.

From the foregoing, it can be seen that the connection selection policy configured with one or more network transport evaluators accepts a request for a network connection and returns a network connection that best matches the desired characteristics as determined by the evaluators. By appropriately configuring the policy, the device is able to use the most ideal available network transport when making connections.

The above described network transport selection processes benefits developers implementing applications on mobile devices by providing a ready-made mechanism by which the application can obtain the best possible network connection given the application's needs and the device's state. Users benefit from an improved user experience: they do not need to choose a network transport when using/configuring the application, and can trust that the application will use the best network connection at all times given the device's current state.

The above described techniques provides several main benefits over current practices. It eliminates or reduces the need for an application developer to describe and implement a connection-selecting algorithm for a particular application. It allows an application to utilize the best network connection at any given moment given its needs and the state of the device it is running in. It eliminates or reduces the need for the application to ask the user which network transport to use, simplifying configuration and avoiding the scenario where a user chooses a transport that poorly meets the application's needs or the state of the device.

Although embodiments of the present invention have been illustrated in the accompanied drawings and described in the foregoing description, it will be understood that the invention is not limited to the embodiments disclosed, but is capable of numerous rearrangements, modifications, and substitutions without departing from the spirit of the invention as set forth and defined by the following claims. For example, the capabilities of the invention can be performed fully and/or partially by one or more of the blocks, modules, processors or memories. Also, these capabilities may be performed in the current manner or in a distributed manner and on, or via, any device able to provide and/or receive information. Further, although depicted in a particular manner, various modules or blocks may be repositioned without departing from the scope of the current invention. Still further, although depicted in a particular manner, a greater or lesser number of modules and connections can be utilized with the present invention in order to accomplish the present invention, to provide additional known features to the present invention, and/or to make the present invention more efficient. Also, the information sent between various modules can be sent between the modules via at least one of a data network, the Internet, an Internet Protocol network, a wireless source, and a wired source and via a plurality of protocols.

What is claimed is:

1. A method for selecting a network transport for a device from a plurality of network transports, the method comprising:
a. generating a connection request;
b. referencing a connection selection policy to select a network transport;
c. connecting the device on the selected network transport.

2. The method of claim 1 comprising:
a. defining the connection selection policy; and
b. storing the connection selection policy on the device.

3. The method of claim 2 comprising defining one or more network transport evaluators, each network transport evaluator configured to assess a network transport's suitability against one or more connection characteristics.

4. The method of claim 3 wherein the one or more network transport evaluators comprises a Geolocation Evaluator configured to weight the plurality of network transports according to a geographical area of the device.

5. The method of claim 3 wherein the one or more network transport evaluators comprises a Security Evaluator configured to weight the plurality of network transports according to their respective encryption capabilities.

6. The method of claim 3 wherein the one or more network transport evaluators comprises a Battery Conserving Evaluator configured to weight the plurality of network transports according to their power usage.

7. The method of claim 3 comprising weighting an output of each of the network transport evaluators to determine the most appropriate network transport.

8. The method of claim 1 comprising:
a. determining a device state;
b. providing the device state to the connection selection policy; and
c. selecting the network transport dependent on the device state.

9. The method of claim 1 wherein the connection request is generated by an application executing on the device.

10. A mobile device configured to:
a. execute one or more applications comprising generating a connection request; and
b. execute a connection selection policy in response to the connection request, the connection selection policy being configured to select one network transport for a connection of the device from a plurality of network transports.

11. The mobile device of claim 10 wherein the connection selection policy comprises one or more network transport evaluators, each network transport evaluator configured to weight each of the plurality of network transports according to one or more criteria.

12. The mobile device of claim 11 wherein the one or more network transport evaluators comprises a Geolocation Evaluator configured to weight the plurality of network transports according to a geographical area of the device.

13. The mobile device of claim 11 wherein the one or more network transport evaluators comprises a Security Evaluator configured to weight the plurality of network transports according to their respective encryption capabilities.

14. The mobile device of claim 11 wherein the one or more network transport evaluators comprises a Battery Conserving Evaluator configured to weight the plurality of network transports according to their power usage.

15. The mobile device of claim 11 wherein the connection selection policy is configured to weight an output of each of the network transport evaluators to determine the most appropriate network transport.

16. A non-transitory computer-readable storage medium comprising instructions for:
a. receiving a connection request for a mobile device; and
b. executing a connection selection policy to select a network transport for connecting the mobile device from a plurality of network transports.

17. The computer-readable storage medium of claim 16 comprising instructions for evaluating at least one network transport evaluator for each of the plurality of network transports.

18. The computer-readable storage medium of claim 17 wherein the at least one network transport evaluator comprises a Geolocation Evaluator and wherein the computer-readable storage medium comprises instructions for weighting the plurality of network transports according to a geographical area of the device.

19. The computer-readable storage medium of claim 17 wherein the at least one network transport evaluator comprises a Security Evaluator and wherein the computer-readable storage medium comprises instructions for weighting the plurality of network transports according to their respective encryption capabilities.

20. The computer-readable storage medium of claim 17 wherein the at least one network transport evaluator comprises a Battery Conserving Evaluator and wherein the computer-readable storage medium comprises instructions for weighting the plurality of network transports according to their power usage.
